(19) United States
(12) Patent Application Publication
(10) Pub. No.: US 2014/0150728 A1
(43) Pub. Date: Jun. 5, 2014

(54) DOOR FOR HOUSEHOLD PET CARRIER

(71) Applicant: Mid-West Metal Products Co., Inc., Muncie, IN (US)

(72) Inventor: Giovanni Battista Tamiozzo, Creazzo (Vicenza) (IT)

(21) Appl. No.: 13/900,759

(22) Filed: May 23, 2013

(30) Foreign Application Priority Data
Jun. 12, 2012 (IT) VI2012A000329

(51) Int. Cl. E06B 11/02; A01K 1/00; E06B 11/04; A01K 1/02

(52) U.S. Cl. CPC E06B 11/022; A01K 1/0245; A01K 1/0035; E06B 11/04
USPC 119/501; 49/394; 49/226

(57) ABSTRACT

A door is provided for a household pet carrier having a substantially parallelepiped box shape, with an opening on one of the sides of the box structure allowing the animal to enter and exit the carrier. Said opening can be closed reversibly by means of a door which prevents the animal inside from leaving the carrier. The door of the invention is essentially characterized in that it cannot be opened as in the case of similar known doors, with an opening having vertical-axis leaves, but rather by spreading apart the two leaves, of which it is made, in compass fashion, and said leaves, instead of becoming coplanar as in the closed position, assume a spread-apart position, with the hinge axis between the two leaves of the door being located, in this case, outside the container.

### RELATED APPLICATIONS

This application claims the benefit of priority to Italian Industrial patent application serial number VI2012A000329, filed on Jun. 12, 2012, which is hereby incorporated by reference in its entirety.

### FIELD OF THE INVENTION

The present invention relates to a household pet carrier, and in particular to a door for a household pet carrier.

### BACKGROUND

Carriers for household pets, typically dogs and cats, but also rabbits, rodents, and other small mammals, have been known for a long time and are quite common. These carriers generally come in the form of a substantially parallelepiped box and are provided with an opening on one of the sides of the box structure, allowing an animal to enter and exit the carrier. The opening substantially occupies the entire surface of said side and can be closed reversibly by means of a door which prevents the animal inside from leaving the carrier. Naturally, the door has means for keeping it in the closed position as desired by the user, preventing the animal inside the carrier from being able to open the door from the inside of the container with its paws or snout when it is closed.

In practice, such carriers serve as a cage for the animal inside the carrier both for transport, such as in an automobile, and for special situations in which the animal needs to be contained, such as when waiting in the waiting room of a veterinary clinic or when one wishes to keep the animal enclosed while people who are afraid of the animal are present (for example, children).

In most cases, such carriers are not made of a single piece but instead consist of two half-shells, one sitting atop the other with their respective concave portions facing each other. Very often these two half-shells form the two halves of the carrier, placed symmetrically with respect to the horizontal median plane of the carrier. Naturally, there are means for reversible attachment of the two half-shells.

The fact that the carrier is not made of a single piece enables noteworthy construction and functional benefits, because this makes it much simpler and faster to clean the inside and also makes it possible to reduce the overall dimensions when the carrier is not in use.

Concerning the opening and closing of the door on the carrier, it is generally in the form of a lattice and is often made of a metallic material or a plastic material that is sufficiently hard and strong. The lattice configuration of the door allows the animal inside the carrier to have more light and to see the outside surroundings, so that the animal is reassured by the master's presence in situations which could cause emotional distress for the animal.

Carrier doors of the known type are currently made with a vertical opening axis. In practice, this axis coincides with one of the side edges of the opening where the hinging components of the carrier door are located. The closure means referred to earlier are located along the vertical edge of the other side of the opening.

Sometimes this type of opening is inconvenient because the user does not always have enough space in front of the carrier to completely open the door and allow the animal to easily exit the carrier.

Thus, there is a need to provide a door for a domestic pet carrier which can overcome these drawbacks, thus allowing the door to be opened even when there is not much space in front of the door. In addition, there is a need to provide special closure means to be used on said door affording easy closure operation for the user, while ensuring secure closure of the door and preventing the animal inside the carrier from opening the door.

### SUMMARY

According to one embodiment, a door of a pet carrier can include a pair of stacked leaves, both hinged along a horizontal axis, with the upper leaf hinged at its upper edge to an upper edge of a carrier's opening, while said upper leaf is hinged at its lower edge to an upper edge of the lower leaf The carrier can be opened by spreading the two leaves apart in compass fashion, at which point, instead of being positioned in the same plane as when in the closed position, the leaves are placed in a spread-apart position with the hinge axis between the two portions of the door in this case being located outside the container.

The closure means of the door can be advantageously designed to act by preventing its two portions from spreading apart from each other, which therefore remain positioned along the same plane, thus keeping the door in the closed position. In addition, it is possible in the open position to allow the upper leaf to rotate about its hinge axis at the upper edge of the carrier opening and to have the lower leaf overlap the upper leaf, thus completely opening the carrier.

### BRIEF DESCRIPTION OF THE DRAWINGS

The above-mentioned aspects of the present invention and the manner of obtaining them will become more apparent and the invention itself will be better understood by reference to the following description of the embodiments of the invention, taken in conjunction with the accompanying drawings, wherein:

FIG. 1 is a perspective view of one embodiment of a pet carrier with a door in a closed position;

FIG. 2 is a perspective view of the pet carrier of FIG. 1 in a partially open position;

FIG. 3 is a perspective view of the pet carrier of FIG. 1 in an open position;

FIG. 4 is a side view of the pet carrier of FIG. 1 in a partially open position;

FIG. 5 is a perspective view of a door closure member; and

FIG. 6 is a partially exploded perspective view of the door closure member of FIG. 5.

Corresponding reference numerals are used to indicate corresponding parts throughout the several views.

### DETAILED DESCRIPTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

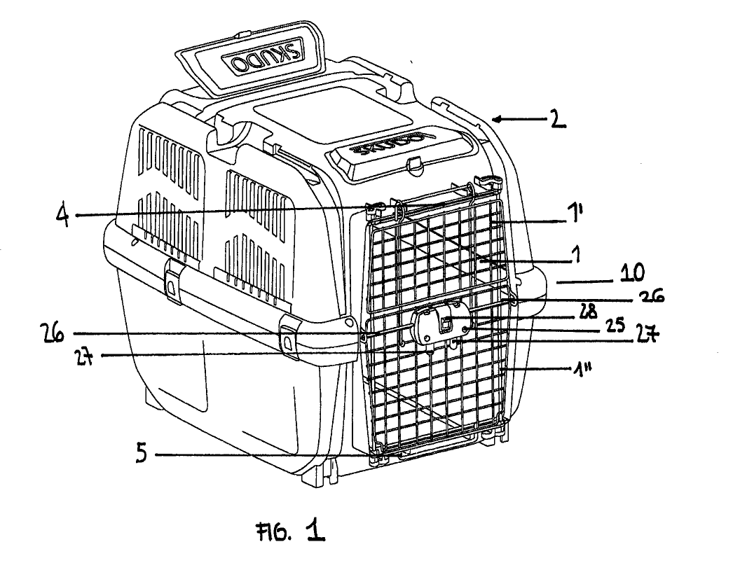

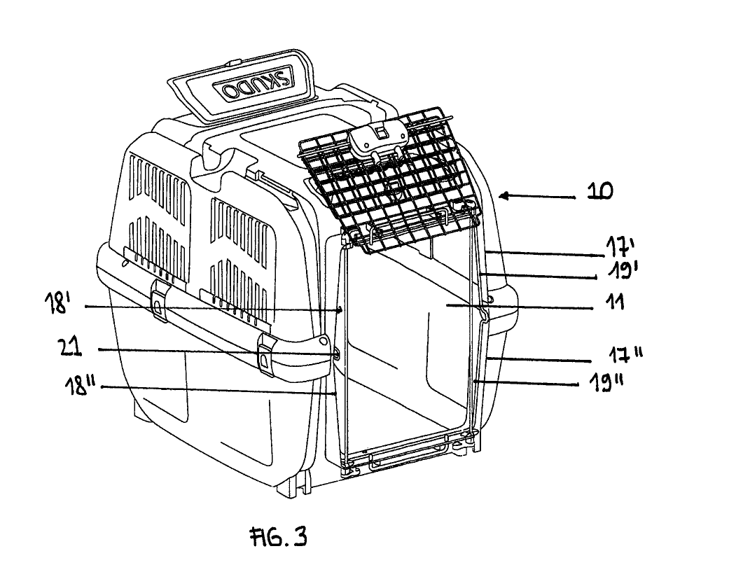

In FIG. 1, a door 1 for a carrier 10 for household pets is shown. This carrier 10, with known means, can have a box-like shape with an opening 11 (see FIG. 3) made in one of the sides of the box-like structure, which substantially occupies the entire surface of said side for the purpose of allowing the animal to enter and exit the carrier 10. The door 1 serves the specific purpose of preventing the animal in the carrier 10 from leaving or escaping therefrom. The door 1 can be opened when desired by the user, but means are provided to keep the door 1 closed with the animal inside without the animal having the possibility of opening the door 1 from the inside which would allow it to escape from the carrier 10 against the master's wishes.

According to the present disclosure, said door 1 is designed to consist of a first portion 1′ and a second portion 1″, respectively. The two portions are hinged together along a horizontal axis. First or upper portion 1′ is hinged by its upper edge to an upper edge 4 of the door 1 and at its lower edge to the upper edge of the second or lower portion 1″. Referring to FIG. 1, when the door 1 is in the closed position the lower edge of the second portion 1″ rests on a lower edge 5 of the carrier 10.

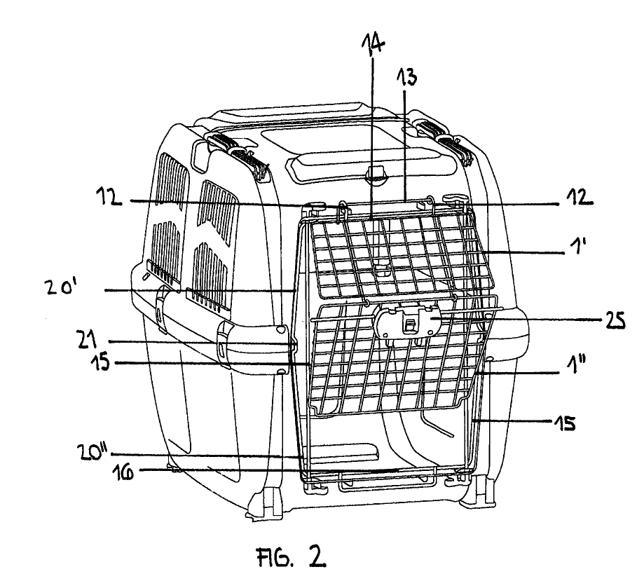

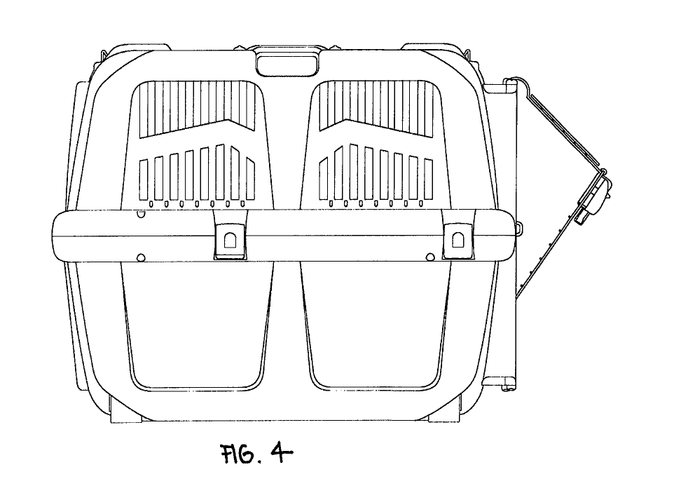

In FIG. 2, the door can be partially opened by spreading the two portions 1′, 1″ apart in a compass-like manner. Here, the two portions of the door 1 are moved from being disposed in the same plane in the closed position (FIG. 1) to a partially spread-apart, non-planar position (see FIG. 2). In this case, the hinge or pivot axis A between portions 1′ and 1″ of the door 1 is positioned outside or away from the carrier 10 as shown in FIG. 4.

As first or upper portion 1′ continues to be lifted and the two portions 1′, 1″ are further spread apart from each other, the door continues to move to a more open position to free up increasingly larger portions of the opening 11 until said opening 11 is completely free of the presence of the door (i.e., FIG. 3). In the open position shown in FIG. 3, the two portions 1′, 1″ can now overlap one another and rest on an upper surface 2 of the carrier 10.

From an operating standpoint, the door can be structured so that it is not directly hinged to the upper end of the opening 11, but rather can be coupled to an upper structural element 13 via two hooks 12. The structural element 13 can be secured to an upper, horizontal side 14 of a frame positioned at the edges of the opening 11. The frame can have two vertical sides 15 and one lower horizontal element 16 (i.e., frame defined by elements 14, 15, and 16). However, the presence of this frame located substantially at the edges of opening 11 only serves to facilitate the construction aspect and the functionality of the device, and does not interfere with the characteristic feature of this embodiment. In FIGS. 1 and 2, in this embodiment, opening 11 is defined substantially vertically with respect to the carrier 10. The opening 11 can be closed or covered by the door 1. In the open position, however, the opening 11 is not defined by perfectly vertical sides but rather is defined by two portions, i.e., a first side 17′, 17″ and a second side 18′, 18″, spread apart from each other with an angle slightly less than 180° (see FIG. 3).

Referring to FIGS. 2 and 3, adjacent to the two opening portions 17′, 17″ and 18′, 18″ are corresponding frame sections 19′, 19″ and 20′, 20″ which are secured to vertical elements 15 of the frame and which are substantially aligned with and parallel to the edges of the defined opening 11.

At about the centerline of said opening and door frame, i.e., where the opening 11 is at approximately its widest dimension, elements 19′, 19″ and 20′, 20″ are connected ton one another by eyelets 21 which extend to the outside of the carrier 10 and whose function will be described below.

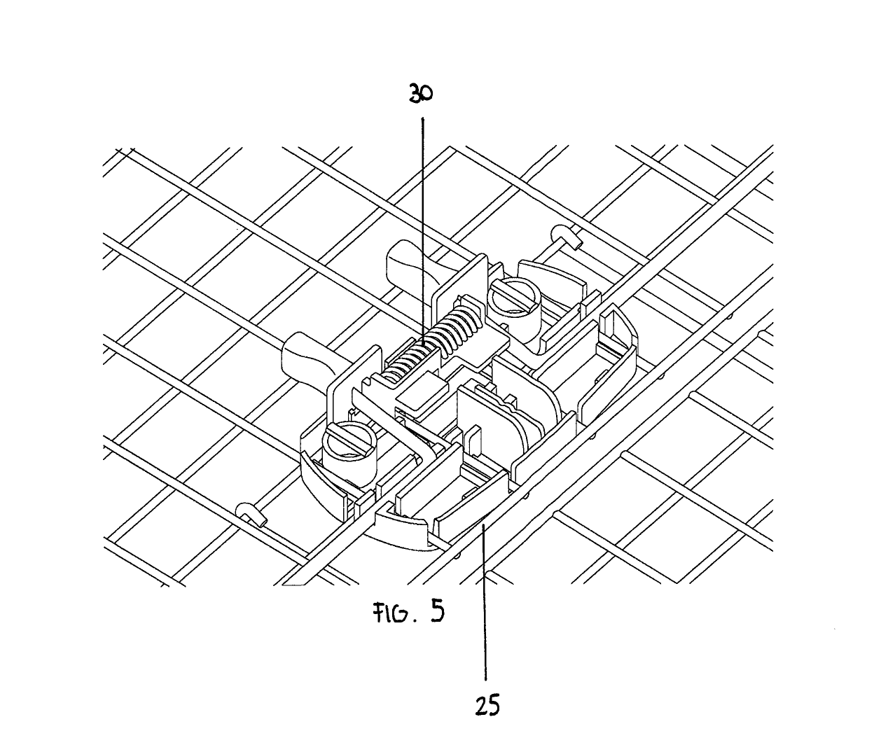

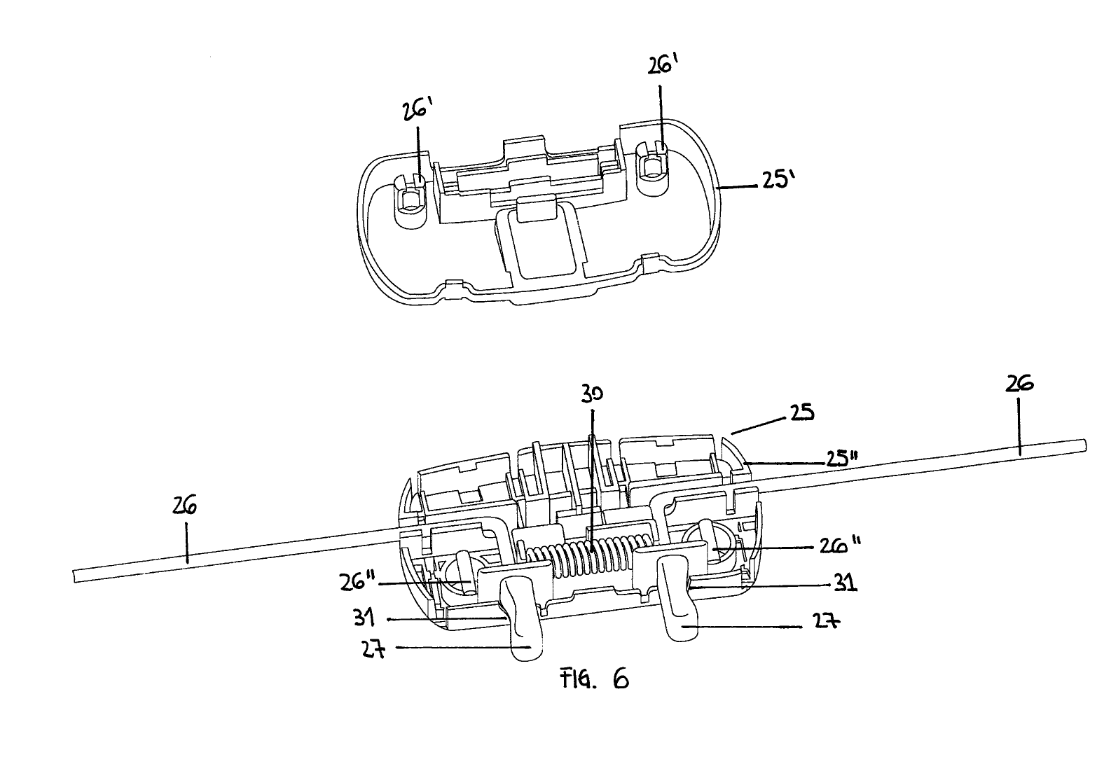

Referring now generally to FIGS. 1-4 and in further detail in FIGS. 5-6, a device 25 can be provided as a door closure or locking element. In this embodiment, this device 25 is placed at the upper end of second portion 1″ of the door 1. Here, the closure device 25 can actuate a pair of horizontally positioned rods 26 by means of a pair of movable protrusions 27. When said protrusions are configured in the release position (i.e., FIG. 1), each end of the two horizontally positioned rods 26 can be disposed in the eyelets 21, thereby preventing the first portion 1′ and second portion 1″ of the door 1 from moving apart from one another so that the door 1 remains closed.

However, as the two protrusions 27 are moved towards one another, thereby overcoming the opposing force of an elastic means (e.g., a spring), the two horizontal rods 26 can move slightly towards the interior of the door such that the ends of the rods 26 come out of or are released from the eyelets 21. As such, this makes it possible to spread apart or move the two portions 1′ and 1″ away from one another so that the door 1 can be opened.

A locking mechanism in the form of a push button 28 (FIG. 1) can slide vertically between two positions. In one position, the action of moving the two rods 26 towards the interior of the door 1 is prevented by the locking mechanism, i.e., locks the door 1 in the closed position. In the second position, however, this action is allowed, thereby making it possible to open and close the door freely by acting or moving the two lower protrusions 27 toward one another. In this aspect, the push button 28 serves as a locking means for maintaining the door 1 in the closed position (FIG. 1), thus preventing the two protrusions 27 from being moved together to open the door 1.

As shown in FIGS. 5 and 6, the device 25 can have a box or rectangular-like structure formed by two removably coupled shells 25′, 25″. The shells 25′, 25″ are coupled to one another and equipped with means 26′, 26″ for latching the two shells 25′, 25″ to each other. The two protrusions 27, each of which is secured to a rod 26, are held in the position shown in FIGS. 5 and 6 (i.e., disposed apart from one another by a predefined distant position) by means of an elastic part 30. The elastic part can be, for example, a helical spring. In the rest position, protrusions 27 are disposed against a wall 31 made in shell 25′ which prevents the two protrusions 27 from moving away from each other within a certain limit. In this embodiment, the walls 31 can define the maximum distance between the two protrusions 27. When the user grasps the two protrusions 27 with his/her fingers and moves them closer together, thereby overcoming the elastic force of elastic member 30, the two rods 26 are also brought closer together such that their ends come out of or disengage from the eyelets 21. This allows the door to be free so that there is nothing to prevent the two portions 1′, 1″ of the door 1 from being spread or moved apart towards a partially or fully open position.

Consequently, it is clear from the above that the door 1 can be relatively simplistic from a design and functional standpoint and is advantageous compared to similar known doors in that a large amount of space is not needed to open the door.

It is also noted that the door 1 of this disclosure can have construction forms which differ from those illustrated and described, without its essential features exceeding the scope of this disclosure. This disclosure is also considered to include household pet carriers which are equipped with the door illustrated and described above, along with other similar crates, cages, and carriers.

While exemplary embodiments incorporating the principles of the present invention have been disclosed hereinabove, the present invention is not limited to the disclosed embodiments. Instead, this application is intended to cover any variations, uses, or adaptations of the invention using its general principles. Further, this application is intended to cover such departures from the present disclosure as come within known or customary practice in the art to which this invention pertains and which fall within the limits of the appended claims.

1. A door for a household pet carrier, comprising:
a substantially parallelepiped, box-shaped structure with an opening defined in one of the sides of the structure for allowing an animal to enter and exit the carrier, said opening defining substantially the entire side of said structure and being capable of being at least partially closed to prevent the animal from exiting the carrier;
a carrier door for at least partially covering the opening, the door being moveable between an open position and a closed position, the door having means for maintaining it in the closed position;
wherein, said door comprises a first portion and a second portion being pivotably coupled to one another about a pivot axis, where the first portion is pivotably coupled at its upper edge to a top edge of the carrier and at its lower edge to an upper edge of the second portion;
further wherein, in the closed position the first portion and second portion are disposed in a substantially coplanar orientation and in a partially open position the first and second portions pivot relative to one another such that the pivot axis is disposed at a location outside of and spaced from the carrier.

2. The door of claim 1, further comprising a locking means for preventing the first portion and second portion from moving substantially relative to one another.

3. The door of claim 1, wherein in the open position, the first portion of the door is disposed on a top surface of the structure and the second portion is disposed on top of the first portion.

4. The door of claim 1, wherein the means for maintaining comprises:
a closure device coupled to one of the first portion and second portion of the door, a pair of horizontally-disposed rods operably coupled to the closure device, where one end of each rod is coupled to said closure element and the opposite end thereof is removably coupled to an eyelet disposed on the edges of the structure.

5. The door of claim 4, further comprising an elastic means being disposed inside the closure element between the ends of both rods

6. The door of claim 5, further comprising a pair of protrusions coupled to the elastic means and moveable between a first position and a second position, where in the first position the elastic means is compressed to decouple the rods from the eyelets and in the second position the elastic means is extended to couple the rods and eyelets to one another.

7. The door of claim 6, wherein the pair of protrusions is biased by the elastic member to the second position.

8. The door of claim 6, further comprising a push button coupled to the closure member and being moveable between two positions, where in one position the push button prevents the protrusions from being moved from the second position to the first position and in the other position the protrusions are free to move between the first and second positions.

9. A pet carrier, comprising:
a front, a back, a top, a bottom, a first side and a second side;
a door frame coupled to one of the front, back, first side and second side, the door frame including a top member, a bottom member, a first side member, and a second side member, where the door frame defines an opening to allow entry and exit from an interior of the carrier;
an eyelet formed in the first side member and the second side member;
a door pivotably coupled to at least the top member of the door frame, the door including a first portion and a second portion pivotably coupled to one another about a pivot axis; and
a latching mechanism coupled to either the first or second portions, the latching mechanism including a first wire and a second wire, the first wire being removably engaged to the eyelet formed in the first side member and the second wire being removably engaged to the eyelet formed in the second side member;
wherein, the door is moveable between a closed position in which the first and second portions are disposed substantially planar with one another and an open position in which the pivot axis is positioned at a location outside of and away from the carrier.

10. The pet carrier of claim 9, wherein in the open position the first portion is disposed above the top of the carrier and the second portion is on top of the first portion.

11. The pet carrier of claim 9, wherein in a partially open position, the first portion and second portion are disposed at an angle less than 180° and the pivot axis is spaced from the opening.

12. The pet carrier of claim 9, wherein the latching mechanism comprises an outer housing formed by a first shell and a second shell.

13. The pet carrier of claim 12, wherein the first shell includes a first coupling means and the second shell includes a second coupling means, where the first coupling means and second coupling means are coupled to one another to form the outer housing.

14. The pet carrier of claim 9, wherein the latching mechanism comprises a first element movably coupled to the first wire and a second element movably coupled to the second wire.

15. The pet carrier of claim 14, further comprising an elastic member predisposed between the first element and second element, where the elastic member biases the first element and second away from one another.

16. The pet carrier of claim 15, wherein the first element and second element are movable between a first position and a second position, where in the first position the first element and second element are spaced a maximum distance from one another.

17. The pet carrier of claim 16, wherein in the second position the first wire and second wire are disengaged from the eyelets.

18. The pet carrier of claim 16, wherein in the second position the elastic member is disposed in a compressed position.

19. The pet carrier of claim 9, further comprising a locking mechanism coupled to the latching mechanism for maintaining the door in the closed position.

20. The pet carrier of claim 19, wherein the locking mechanism is movable between a first position and a second position, where in the first position the first and second wires are maintained in engagement with the eyelets and in the second position the first and second wires are movable between an engaged position and a disengaged position.
